(19) United States
(12) Patent Application Publication
(10) Pub. No.: US 2006/0132816 A1
(43) Pub. Date: Jun. 22, 2006

(54) Image forming device, image forming method, and computer readable recording medium stored with image forming program

(75) Inventors: Kazuto Yamamoto, Kunitachi-shi (JP); Masakatsu Kiwada, Sagamihara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/181,732

(22) Filed: Jul. 15, 2005

(30) Foreign Application Priority Data
Dec. 21, 2004 (JP) 2004-369391

(51) Int. Cl. G06F 3/12

(52) U.S. Cl. 358/1.13

(57) ABSTRACT

An image forming device makes a judgment on whether a bundling process for bundling a plurality of printed recording media is instructed or not, when a process for writing image data to be printed on the recording media into an electronic tag is instructed. The device selects only recording media each provided with an electronic tag as the recording media for printing and writes image data to be printed on each recording medium into the electronic tag of the corresponding recording medium, when the bundling process is not instructed. The device selects a recording medium provided with an electronic tag and a recording medium provided with no electronic tag as the recording media for printing and writes into the electronic tag of the recording medium with the electronic tag the entire image data to be printed on a plurality of recording media, when the bundling process is instructed.

This application is based on Japanese Patent Application No. 2004-369391 filed on Dec. 21, 2004, the contents of which are hereby incorporated by reference.

### BACKGROUND OF THE INVENTION

1. Field of the Invention

The invention relates to an image forming device, an image forming method, and a computer readable recording medium stored with an image forming program. The invention relates particularly to an image forming device, an image forming method, and a computer readable recording medium stored with an image forming program capable of writing into an IC tag provided on paper image data for printing on paper.

2. Description of the Related Art

An image forming device is disclosed (refer to Unexamined Publication No. JP-A-2002-337426) for printing images on paper based on data received from external equipment such as a PC (personal computer) as well as for writing data into an IC tag, if the received data contains some data to be written into the IC tag, which is provided on the paper. Also, proposed is an image forming device capable of writing image data into an IC tag provided on each sheet of paper, the image data being the one to be printed on the particular sheet.

With such an image forming device, visual recognition information is available for the user to recognize the contents easily by visual inspection while the data stored in the IC tag allows the user to control and use it as electronic information.

However, the abovementioned image forming devices had a problem that they select and use paper provided with an IC tag each time when they receive an instruction to write data into an IC tag, which results in an increase in the consumption of expensive paper provided with an IC tag, which in turn resulting in the increase of printing cost.

### OBJECTS AND SUMMARY

It is an object of the present invention to provide an image forming device, an image forming method, and a computer readable recording medium stored with an image forming program, which are all improved to solve the abovementioned problems.

It is another object of the present invention to provide an image forming device, an image forming method, and a computer readable recording medium stored with an image forming program capable of providing visual and digital information simultaneously while suppressing the increase of printing cost.

According to an embodiment of the invention, there is provided an image forming device, comprising: a judgment unit for making a judgment on whether a bundling process for bundling a plurality of printed recording media is instructed or not, when a process for writing image data to be printed on the recording media into an IC tag is instructed; a first mode execution unit for executing a first mode of selecting only recording media each provided with an IC tag as the recording media for printing and writing into the IC tag of each recording medium the image data to be printed on the corresponding recording medium, when it is judged that said bundling process is not instructed; and a second mode execution unit for executing a second mode of selecting a recording medium provided with an IC tag and a recording medium provided with no IC tag as the recording media for printing and writing into said IC tag of the recording medium provided with the IC tag the entire image data to be printed on a plurality of recording media, when it is judged that said bundling process is instructed.

This invention makes it possible to reduce the consumption amount of expensive recording media provided with IC tags. Therefore, it enables us to curb the rise of printing cost while maintaining both visual and digital information simultaneously by a bundling process.

According to another embodiment of the invention, there is provided an image forming device, comprising: a judgment unit for making a judgment on whether a bundling process for bundling a plurality of printed recording media is instructed or not, when a process for writing image data to be printed on the recording media into an IC tag is instructed; a first mode execution unit for executing a first mode of selecting only recording media each provided with an IC tag as the recording media for printing and writing into the IC tag of each recording medium the image data to be printed on the corresponding recording medium, when it is judged that said bundling process is not instructed; and

a second mode execution unit for executing a second mode of selecting only a recording medium provided with no IC tag for printing and writing into an IC tag of a bundling member equipped with the IC tag used for said bundling process the entire image data to be printed on a plurality of recording media, when it is judged that said bundling process is instructed.

According to still another embodiment of the invention, there is provided an image forming method comprising the steps of: 1) making a judgment on whether a bundling process for bundling a plurality of printed recording media is instructed or not, when a process for writing image data to be printed on the recording media into an IC tag is instructed; 2) executing a first mode of selecting only recording media each provided with an IC tag as the recording media for printing and writing into the IC tag of each recording medium the image data to be printed on the corresponding recording medium, when it is judged that said bundling process is not instructed; and 3) executing a second mode of selecting a recording medium provided with an IC tag and a recording medium provided with no IC tag as the recording media for printing and writing into said IC tag of the recording medium provided with the IC tag the entire image data to be printed on a plurality of recording media, when it is judged that said bundling process is instructed.

According to a further embodiment of the invention, there is provided an image forming method comprising the steps of: 1) making a judgment on whether a bundling process for bundling a plurality of printed recording media is instructed or not, when a process for writing image data to be printed on the recording media into an IC tag is instructed; 2) executing a first mode of selecting only recording media each provided with an IC tag as the recording media for printing and writing into the IC tag of each recording medium the image data to be printed on the corresponding recording medium, when it is judged that said bundling process is not instructed; and 3) executing a second mode of selecting only a recording medium provided with no IC tag for printing and writing into an IC tag of a bundling member equipped with the IC tag used for said bundling process the entire image data to be printed on a plurality of recording media, when it is judged that said bundling process is instructed.

According to a further embodiment of the invention, there is provided a computer readable recording medium stored with a computer readable recording medium stored with an image forming program, said image forming program causing an image forming device to execute a process comprising the steps of: 1) making a judgment on whether a bundling process for bundling a plurality of printed recording media is instructed or not, when a process for writing image data to be printed on the recording media into an IC tag is instructed; 2) executing a first mode of selecting only recording media each provided with an IC tag as the recording media for printing and writing into the IC tag of each recording medium the image data to be printed on the corresponding recording medium, when it is judged that said bundling process is not instructed; and 3) executing a second mode of selecting a recording medium provided with an IC tag and a recording medium provided with no IC tag as the recording media for printing and writing into said IC tag of the recording medium provided with the IC tag the entire image data to be printed on a plurality of recording media, when it is judged that said bundling process is instructed.

According to a further embodiment of the invention, there is provided a computer readable recording medium stored with a computer readable recording medium stored with an image forming program, said image forming program causing an image forming device to execute a process comprising the steps of: 1) making a judgment on whether a bundling process for bundling a plurality of printed recording media is instructed or not, when a process for writing image data to be printed on the recording media into an IC tag is instructed; 2) executing a first mode of selecting only recording media each provided with an IC tag as the recording media for printing and writing into the IC tag of each recording medium the image data to be printed on the corresponding recording medium, when it is judged that said bundling process is not instructed; and 3) executing a second mode of selecting only a recording medium provided with no IC tag for printing and writing into an IC tag of a bundling member equipped with the IC tag used for said bundling process the entire image data to be printed on a plurality of recording media, when it is judged that said bundling process is instructed.

The objects, characteristics and properties of this invention other than those set forth above will become apparent from the description given herein below with reference to preferred embodiments illustrated in the accompanying drawings.

### BRIEF DESCRIPTION OF THE DRAWINGS

FIG. 1 is a schematic front view showing the constitution of a MFP, which serves as an image forming device according to a first embodiment of the present invention.

FIG. 2 is a block diagram showing the constitution of the MFP shown in FIG. 1.

FIG. 3 is a schematic diagram showing a constitution of a sheet of paper provided with an IC tag.

FIG. 4 is a flowchart showing the printing process procedure on the MFP.

FIG. 5 is a flowchart indicating the sequence of the process of a first printing mode.

FIG. 6 is a flowchart indicating the sequence of the process of a second printing mode.

FIG. 7 shows a schematic view of a bundle of paper obtained as a result of executing the second printing mode.

FIG. 8 is a diagram for describing typical electronic data stored in the IC tag of a sheet of paper provided with an IC tag that constitutes the paper bundle shown in FIG. 7.

FIG. 9 is a flowchart indicating the sequence of the process of a third printing mode.

FIG. 10 is a flowchart showing the sequence of a second printing mode process concerning a second embodiment of the invention.

FIG. 11 shows a schematic view of a bundle of paper obtained as a result of executing the second printing mode concerning the second embodiment.

FIG. 12A is a diagram for describing typical electronic data stored in the IC tag of a sheet of paper provided with an IC tag used as the first page of the paper bundle shown in FIG. 11.

FIG. 12B is a diagram for describing typical electronic data stored in the IC tag of a sheet of paper provided with an IC tag used as the second page of the paper bundle shown in FIG. 11.

FIG. 13 is a flowchart showing the sequence of a second printing mode process concerning a third embodiment of the invention.

FIG. 14 shows a schematic view of a bundle of paper obtained as a result of executing the second printing mode concerning the third embodiment.

FIG. 15 is a schematic view of a bundle of paper finished with a book binding process.

### DETAILED DESCRIPTION OF PREFERED EMBODIMENTS

The embodiments of this invention will be described below with reference to the accompanying drawings.

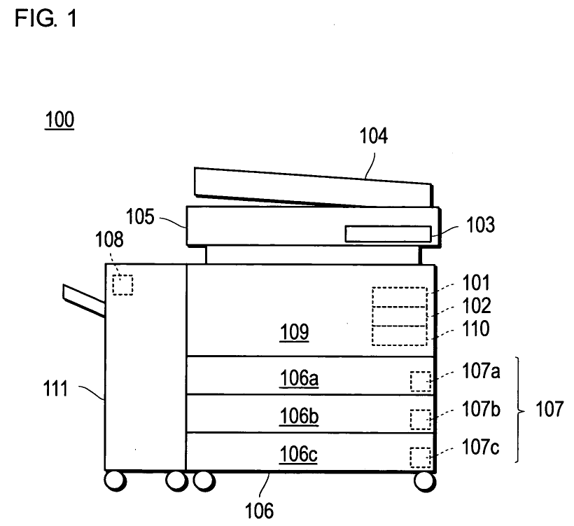

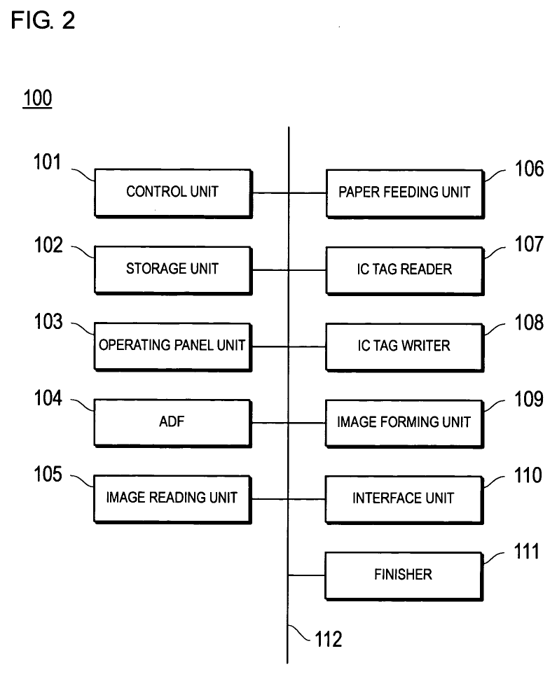

FIG. 1 is a schematic front view showing the constitution of a MFP (Multi-Function Peripheral), which serves as an image forming device according to the first embodiment of the present invention and FIG. 2 is a block diagram showing the constitution of the MFP shown in FIG. 1.

MFP 100 is equipped with a control unit 101, a storage unit 102, an operating panel unit 103, an ADF (Auto Document Feeder) 104, an image reading unit 105, a paper feeding unit 106, an IC tag reader 107, an IC tag writer 108, an image forming unit 109, an interface unit 110, and a finisher 111, all of which are interconnected via a bus 112 for exchanging signals with each other.

The control unit 101 is a CPU, and controls various parts indicated above and executes various arithmetic processes according to a program. The storage unit 102 consists of a ROM for writing various programs and data, a RAM for temporarily writing programs and data as a working area, a hard disk for writing various programs and data including an operating system, etc.

The operating panel 103 is equipped with a touch panel, a ten-key pad, a start button, a stop button and others to be used for displaying various data and entering various instructions.

The ADF 104 transports a single or multiple sheets of paper one sheet at a time to a specified reading position of the image reading unit 105, and discharges the document sequentially after reading it.

The image reading unit 105 irradiates a document set on a specified reading location or transported to the specified reading position by the ADF 104 with a light source such as a fluorescent lamp and the like, converts reflected lights from the document surface into electrical signals with the help of light sensitive devices such as CCD, and generates image data from the electrical signals.

Paper feeding units 106a through 106c contain paper which is used as recording media in the printing process. The paper feeding unit 106 (a collective name for 106a through 106c) feeds the contained paper to the image forming unit 109 one sheet at a time.

IC tag readers 107a through 107c are provided in the neighborhoods of the paper feeding units 106a through 106c respectively. The IC tag readers 107 (a collective name for 107a through 107c) read electronic data stored in the IC tag of the paper with the IC tag to be described later (hereinafter called “IC-tagged paper”). The IC tag reader 107 can read the entire electronic data stored in the IC tag or read the data by each specified unit depending on the instruction of the control unit 101. As the communication system between IC tag reader 107 and the IC tag, those of the international standards such as ISO 14443 and ISO 15693 can be applied using frequency bands such as 135 kHz, 13.56 MHz, and 2.45 GHz. The normally used frequency band is 13.56 MHz and the communication range is approximately 30 cm when said frequency band is used. However, the communication systems that can be applied are not limited to those mentioned above, and other known communication systems or proprietary communication systems may be used.

The IC tag reader 107 can detect whether an IC tag is provided on the paper contained in the paper feeding unit 106. For example, the presence of an IC tag in the paper can be detected by transmitting a radio wave from the IC tag reader 107 and checking if the radio wave is transmitted back from the IC tag to the IC tag reader 107. The method of detecting the presence of an IC tag in the paper is not limited to the method described above, and other detection methods can be used as well. The presence of an IC tag in the paper can be detected immediately before reading the electronic data in the IC tag, when setting the paper to the paper feeding unit 106, when starting up the MFP 100, or at a specified interval.

The IC tag writer 108 is used to write electronic data on IC tags on the IC-tagged paper to be described later. The IC tag writer 108 can be an identical unit as the IC tag reader 107, and the communication system between the IC tag writer 108 and IC tags can be the same as that of the IC tag reader 107.

The image forming unit 109 prints various data on paper using a known imaging process such as the electronic photographing process including such processes as electrical charging, exposure, developing, transferring and fixing.

The interface unit 110 is an interface for communicating with external equipment, and network interfaces such as Ethernet®, Token Ring, and FDDI standards, serial interfaces such as USB and IEEE 1394, parallel interfaces such as SCSI and IEEE 1284, wireless communication interfaces such as Bluetooth®, IEEE 802.11, HomeRF®, and IrDA®, as well as telephone circuit interfaces for connection to telephone circuits can be used.

The finisher 111 conducts finishing processes to be applied to the printed paper transferred from the image forming unit 109. The finishing process includes a bundling process for bundling multiple sheets of printed paper. The bundling process includes a stapling process for stapling a bundle of paper, a punching process for punching holes at paper edges for filing purpose, and bookbinding process for forming a book. The bundling process in the present embodiment is described below using the stapling process as an example. The finishing process may include other processes such as a folding process for folding paper and trimming process for trimming paper edges in addition to the bundling process.

The MFP 100 has the printing function for printing according to an instruction form an external device such as a PC or a cellular telephone, and the copying function for copying documents.

The MFP 100 can include components other than those components mentioned above, or can lack some of the components mentioned above.

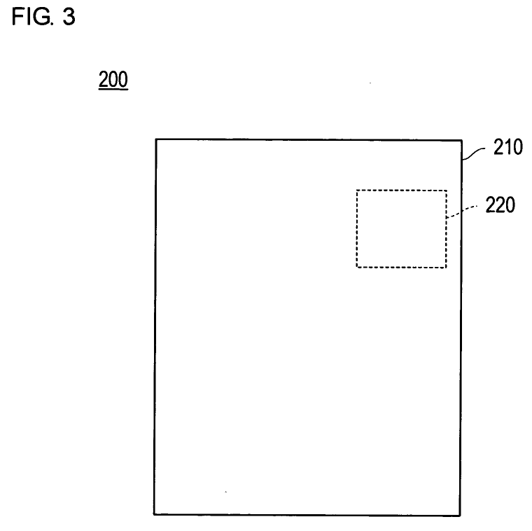

FIG. 3 is a schematic diagram showing a constitution of a sheet of paper provided with an IC tag. The IC-tagged paper 200 is provided with an IC tag 220 at least in a portion of paper 210. The IC tag 220 can be glued on to the paper 210 or embedded in the paper 210. There can be a single IC tag or a multiplicity of IC tags 220 on a single sheet of paper 210.

The IC tag 220 is a non-contacting type electronic tag using wireless communication and contains a memory part consisting of an IC chip and an antenna part consisting of a coil (neither of them shown) in the inside. When the IC tag 220 receives a radio wave emitted from the IC tag reader 107 or the IC tag writer 108, a current runs through the IC tag 220 due to the electromagnetic induction phenomenon. Thus, the IC tag 220 communicates with the IC tag reader 107 or the IC tag writer 108 in order to read or write electronic data.

The operation of the MFP in this embodiment will be described in the following.

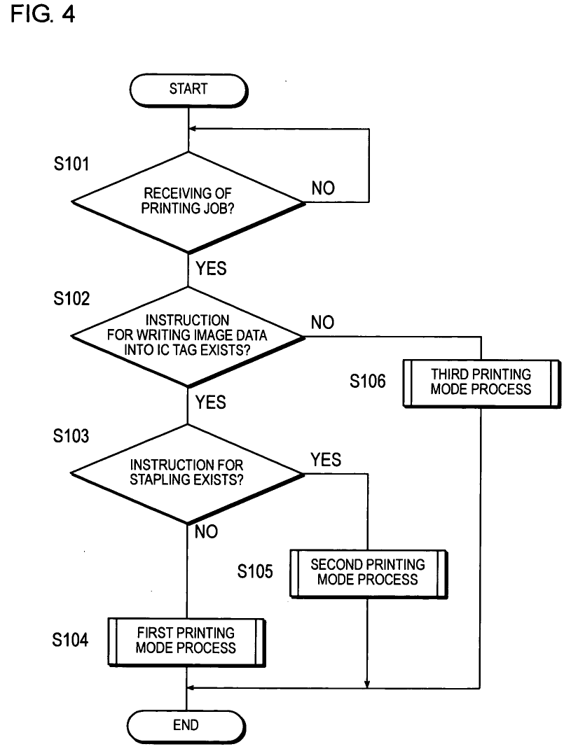

FIG. 4 through FIG. 6 and FIG. 9 represent a flowchart showing the printing process procedure on the MFP 100. The algorithm shown in the flowchart of FIGS. 4 through 6 and 9 is stored as a program in the storage unit 102 of the MFP 100 and executed by the control unit 101.

First, referring to FIG. 4, MFP 100 waits until the printing job is received (S101: No). The printing job herein includes both a job relating to printing based on the data obtained by reading a document using the copying function, and a job relating to printing based on the data received via the interface unit 110 using the printing function. The printing job consists of printing job information concerning the printing job and image data that becomes a printing object to be printed on the paper.

When a printing job is received (S101: Yes), a judgment is made as to whether or not a process for writing into the IC tag the image data to be printed on the paper based on the printing job information contained in the received printing job (S102).

If there exists an instruction for writing the image data into the IC tag (S102: Yes), the process advances to the step S103. In this step S103, a judgment is made as to whether the stapling process is instructed or not based on the printing job information included in the printing job received. As mentioned before, the stapling process is an example of the bundling process. Therefore, said judgment can be whether either one of the stapling process, the punching process, or the bookbinding process that constitute the bundling process, is instructed or not.

If an instruction for the stapling process does not exist (S103: No), the first printing process mode is executed (S104), while the second printing mode process is executed (S105) if an instruction for the stapling process exists (S103: Yes).

On the other hand, if it is judged that the instruction for writing the image data into the IC tag does not exist in the step S102 (S102: No), the third printing mode process is executed (S106).

The first through third printing mode processes will now be described in detail.

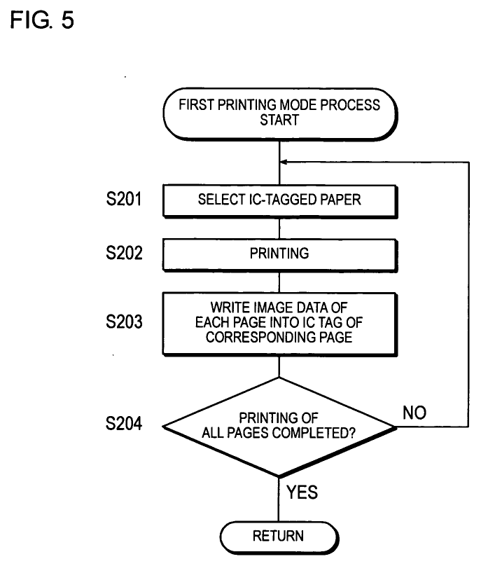

FIG. 5 is a flowchart indicating the sequence of the process of a first printing mode.

In the first printing mode process, only the IC-tagged paper will first be selected as the paper for printing (S201). Next, the entire image data contained in the printing job is printed on paper page by page (S202). Next, the image data to be printed on each sheet of paper is written into the IC tag of each sheet (S203). The processing of these steps S201 through S203 is repeated until all the pages are printed (S204: No), and the program returns to the flowchart of FIG. 4 when all the pages are printed (S204: Yes). The program can also be configured in such a way as to write the image data into the IC tag before printing.

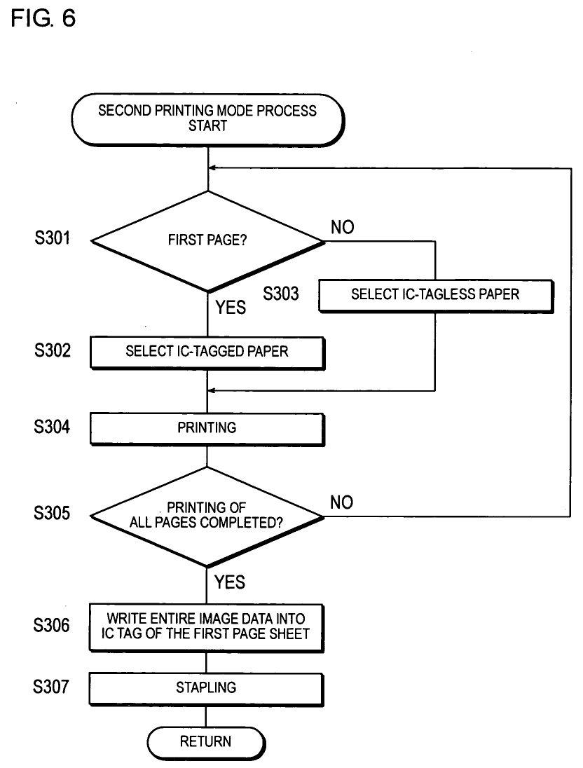

FIG. 6 is a flowchart indicating the sequence of the process of a second printing mode.

In the second printing mode process, a judgment is made first as to whether the object of the process is the first page of the image data consisting of multiple pages or not (S301).

If the object of the process is the first page (S301: Yes), the IC-tagged paper is selected as the paper to be used for printing said page (S302). On the other hand, if the object of the process is not the first page (S301: No), the paper provided with no IC tag (hereinafter called “IC-tagless paper”) is selected as the paper for printing said page (S303).

Next, the entire image data contained in the printing job is printed on paper selected in the step S302 or the step S303 page by page (S304). The processing of these steps S301 through S304 is repeated until all the pages are printed (S305: No), and the program returns to the step S306 when all the pages are printed (S305: Yes).

In the step S306, all the image data to be printed on multiple sheets of paper are written into the IC tag of the paper for the first page. Next, the stapling process is performed on the bundle of the printed sheets of paper (S307), and the program returns to the flow chart of FIG. 4. The program can also be configured in such a way as to write the image data into the IC tag before printing or after stapling.

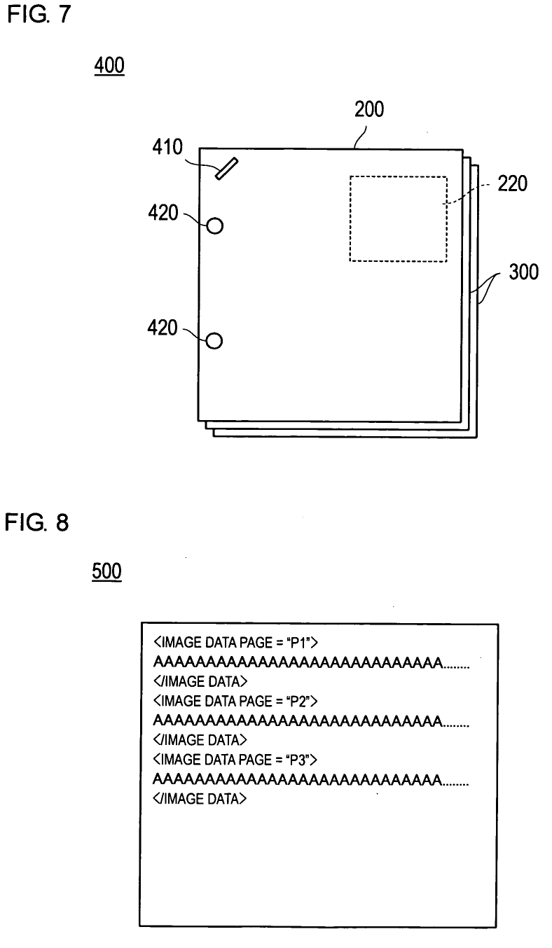

FIG. 7 shows a schematic view of a bundle of paper obtained as a result of executing the second printing mode. A bundle of printing paper 400 contains the IC-tagged paper 200, which is used for the first page, and the IC-tagless paper 300, which is used for other pages, and is stapled using staples 410. FIG. 7 shows an example with punched holes 420.

FIG. 8 is a diagram for describing typical electronic data stored in the IC tag of a sheet of paper provided with an IC tag that constitutes the paper bundle shown in FIG. 7. The electronic data 500 is stored in the memory part of the IC tag 220. The electronic data 500 contains all the image data to be printed on all sheets of the printing paper. Although the electronic data 500 is described in the XML format in FIG. 8, the format of electronic data to be used is not limited to it.

Since the IC-tagged paper and the IC-tagless printing paper are selected for printing when the stapling process is instructed and all the image data is written into the IC tag of the IC tagged paper, the amount of consumption of expensive IC-tagged paper can be minimized. Therefore, it enables us to curb the rise of printing cost while maintaining both visual and digital information simultaneously by the stapling process.

Though the IC-tagged paper is used for printing the first page in this embodiment, the present invention is not limited to it. For example, the IC-tagged paper can be used for printing pages other than the first page and last pages. With such a constitution, accidents of damaging IC tags due to external impacts can be prevented.

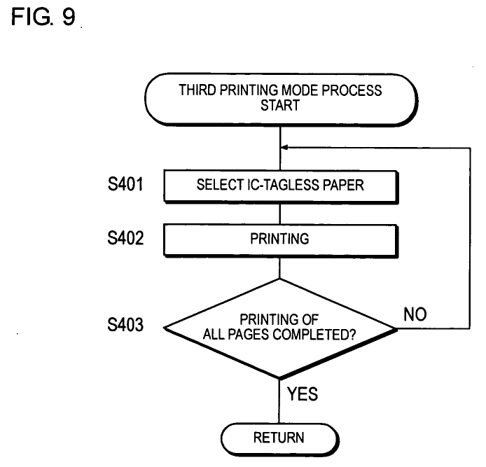

FIG. 9 is a flowchart indicating the sequence of the process of a third printing mode.

In the third printing mode process, only the IC-tagless paper will be selected as the paper for printing (S401). Next, the entire image data contained in the printing job is printed on paper page by page (S402). The processing of these steps S401 and S402 is repeated until all the pages are printed (S403: No), and the program returns to the flowchart of FIG. 4 when all the pages are printed (S403: Yes).

Next, the second embodiment of the invention will be described below. The second embodiment is different from the first embodiment in that multiple sheets of the IC tagged paper are selected in the second printing mode, while the second embodiment is identical to the first embodiment in the first and third printing mode processes. The following description will concentrate mainly on those points that are different from the first embodiment.

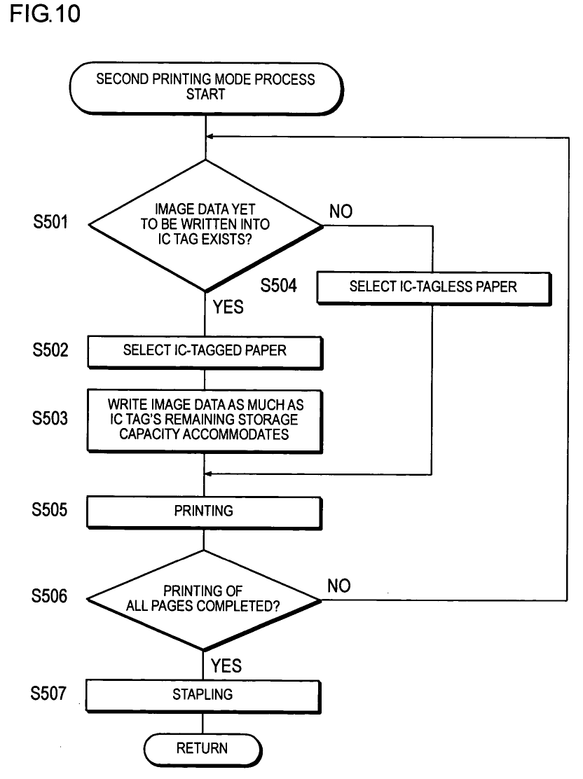

FIG. 10 is a flowchart showing the sequence of a second printing mode process concerning the second embodiment of the invention. The algorithm shown in the flow chart of FIG. 10 is stored as a program in the storage unit 102 of the MFP 100 and executed by the control unit 101.

In the second printing mode process of the second embodiment, a judgment is made as to whether any image data that have not been written into the IC tag or not (S501). The data is written into the IC tag from the image data of the first page followed by image data of other pages in the descending order of the pages.

If there is any data that has not been written into the IC tag (S501: Yes), the IC-tagged paper will be selected as paper to be used for printing pages to be processed (S502). For example, the object of the process in the initial stage is the first page and the image data is not yet written into the IC tag, the IC-tagged paper will be selected as the paper for printing the first page. After the IC-tagged paper is selected, the image data is written into said IC tag as much as possible depending on the remaining storage capacity of said IC tag (S503).

On the other hand, if there is no more image data left to be written into the IC tag, in other words, all the image data for printing the multiple sheets of printing paper is already written into the IC tag (S501: No), the IC-tagless paper will be selected as the printing paper to be used for printing the pages of the process object (S504).

Next, the entire image data contained in the printing job is printed on paper selected in the step S502 or the step S504 page by page (S505). The processing of these steps S501 through S504 is repeated until all the pages are printed (S506: No), and the program returns to the step S507 when all the pages are printed (S506: Yes). In other words, if the entire image data cannot be written into the IC tag used for the first page, additional IC-tagged printing paper is selected and the remaining image data is written into the IC tag(s) to be used for printing the second page and thereafter in the descending order of the pages. However, it is also possible to configure in such a way as to set up a threshold information amount that can be written on each IC tag of a sheet of paper and to select IC-tagged paper when the total image data information amount to be printed on multiple sheets of printing paper exceeds said threshold value.

Next, the stapling process is performed on the bundle of the printed sheets of paper in the step S507, and the program returns to the flowchart of FIG. 4. The process can also be configured in such a way as to write the image data into the IC tag after printing.

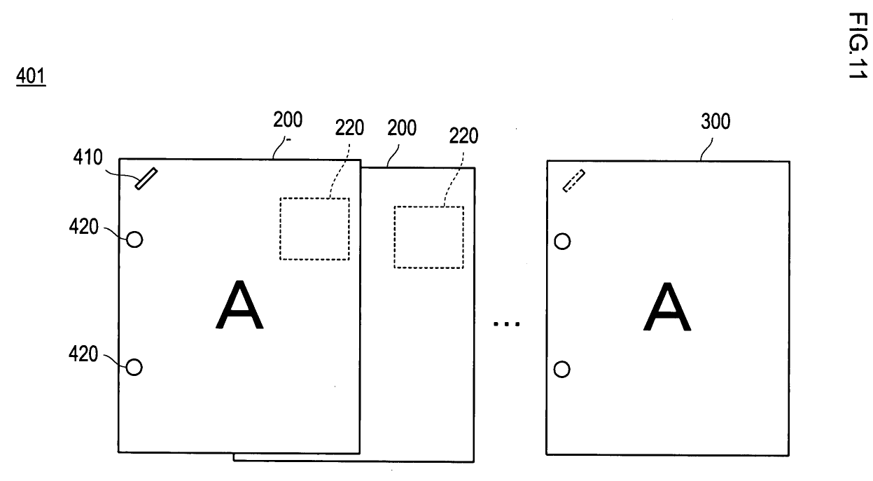

FIG. 11 shows a schematic view of a bundle of paper obtained as a result of executing the second printing mode concerning the second embodiment. A bundle of paper 401 contains the IC-tagged paper 200, 200, which is used for the first and second pages, and the IC-tagless paper 300, which is used for other pages, and is stapled using staples 410. FIG. 11 shows an example with punched holes 420.

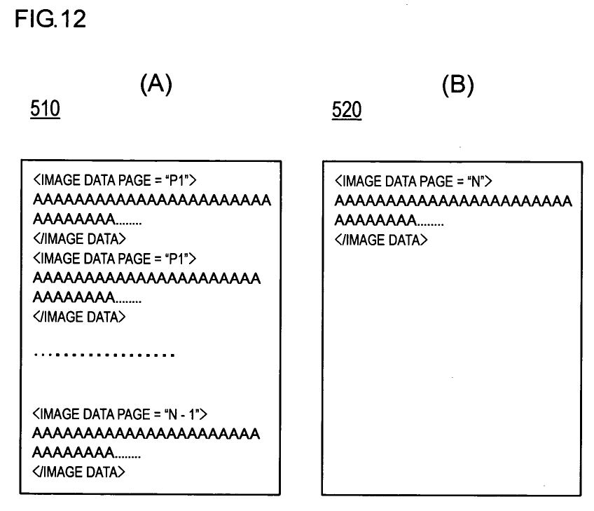

FIG. 12A is a diagram for describing typical electronic data 510 stored in the IC tag of a sheet of paper provided with an IC tag used as the first page of the paper bundle shown in FIG. 11, while FIG. 12B is a diagram for describing typical electronic data 520 stored in the IC tag of a sheet of paper provided with an IC tag used as the second page of the paper bundle shown in FIG. 11. As shown in the diagrams, the image data of the last N pages is stored in the storage part of an IC tag 220 of the IC tagged paper 200 used for the second page because an overflow of the image data occurred in the memory part of an IC tag 220 of the IC tagged paper 200 used for the first page.

As can be seen from the above, the second embodiment provides a similar effect as the first embodiment and makes it possible to write information securely on an IC tag even if the total amount of information of image data to be printed on multiple sheets of paper is large.

Though the IC-tagged paper is used for printing the first page as well as pages following thereafter in this embodiment, the present invention is not limited to it. For example, the IC-tagged paper can be used for printing pages other than the first page and last pages. With such a constitution, accidents of damaging IC tags due to external impacts can be prevented.

Next, the third embodiment of the invention will be described below. The third embodiment is different from the first embodiment in that only IC-tagless paper is selected as the paper to be used for printing in the second printing mode, while the entire image data to be printed on multiple pages is written on an IC tag built into a staple used for the stapling process. The third embodiment is identical to the first embodiment concerning the first and third printing modes. The following description will concentrate mainly on those points that are different from the first embodiment.

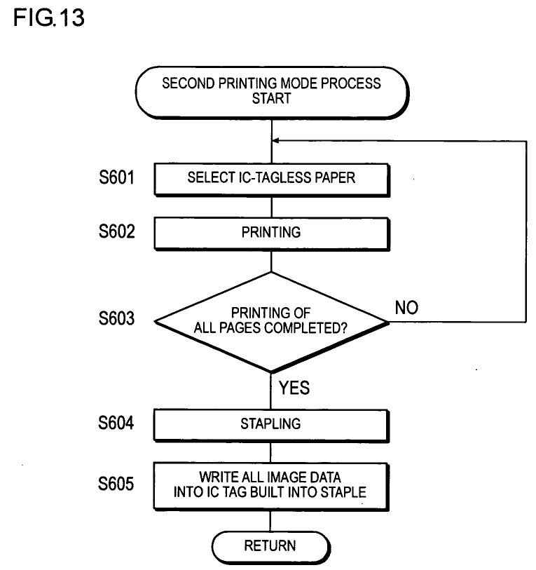

FIG. 13 is a flowchart showing the sequence of a second printing mode process concerning the third embodiment of the invention. The algorithm shown in the flow chart of FIG. 13 is stored as a program in the storage unit 102 of the MFP 100 and executed by the control unit 101.

In the second printing mode process of the third embodiment, only the IC-tagless paper will be selected as the paper for printing (S601). Next, the entire image data contained in the printing job is printed on paper page by page (S602). The processing of these steps S601 through S602 is repeated until all the pages are printed (S603: No), and the program returns to the step 604 when all the pages are printed (S603: Yes).

The bundle of the printed paper is stapled in the step S604. Next, the entire image data to be printed on multiple sheets of paper is written into the IC tag built into the staple (S605) and the program returns to the flowchart of FIG. 4.

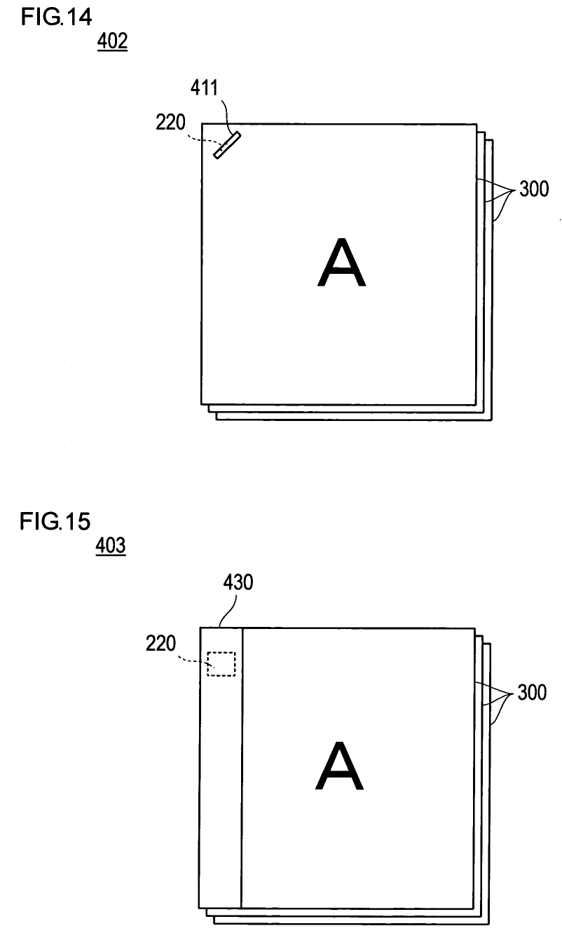

FIG. 14 shows a schematic view of a bundle of paper obtained as a result of executing the second printing mode concerning the third embodiment. The bundle of paper 402 contains multiple sheets of IC-tagless paper 300 and is stapled using a staple 411. The staple 411 used as a bundling device has an IC tag 220 built into it and said IC tag 220 stores the entire image data. The electronic data stored in the IC tag 220 shown in FIG. 14 is the same as the one shown in FIG. 8 (the same thing applies to FIG. 15 which will be described later). Therefore, the third embodiment provides a similar effect as the first embodiment.

While this embodiment shows that the IC tag is provided on the staple used for stapling as an example of the bundling process, the IC tag can be provided on other bundling devices of the bundling process such as those used for the book binding process. FIG. 15 is a schematic view of a bundle of paper finished with a book binding process. A paper bundle 403 contains a plurality of sheets of IC-tagless paper 300 and the book binding process is applied to it using a book binding tape 430. The book binding tape 430 used as a bundling device has an IC tag 220 built into it and said IC tag 220 stores the entire image data. It is also possible to constitute the system in such a way as to store the entire image data in the IC tag provided on other bundling devices such as a book jacket or a cover used for the book binding.

It is obvious that this invention is not limited to the particular embodiments shown and described above but may be variously changed and modified without departing from the technical concept of this invention.

For example, although an MFP is mentioned as the image forming device in the above embodiment, other image forming devices such as a printer and a copying machine can be used as the image forming device of this invention.

The means and method of conducting various processes in the image forming device according to the present invention can be realized by means of a dedicated hardware circuit, or a programmed computer. Said program can be provided either by a computer readable recording medium such as a flexible disk and a CD-ROM, or by being supplied on-line via a network such as the Internet. In this case, the program recorded on the computer readable recording medium is normally transferred to and stored in a storage unit such as a hard disk. Said program can also be provided as independent application software or can be built into the software of the image forming device as a part of its function.

What is claimed is:

1. An image forming device, comprising:
a judgment unit for making a judgment on whether a bundling process for bundling a plurality of printed recording media is instructed or not, when a process for writing image data to be printed on the recording media into an electronic tag is instructed;
a first mode execution unit for executing a first mode of selecting only recording media each provided with an electronic tag as the recording media for printing and writing into the electronic tag of each recording medium the image data to be printed on the corresponding recording medium, when it is judged that said bundling process is not instructed; and
a second mode execution unit for executing a second mode of selecting a recording medium provided with an electronic tag and a recording medium provided with no electronic tag as the recording media for printing and writing into said electronic tag of the recording medium provided with the electronic tag the entire image data to be printed on a plurality of recording media, when it is judged that said bundling process is instructed.

2. An image forming device as claimed in claim 1, wherein
said second mode execution unit selects only one recording medium provided with the electronic tag.

3. An image forming device as claimed in claim 2, wherein
said recording medium provided with the electronic tag is used for printing the first page.

4. An image forming device as claimed in claim 2, wherein
said recording medium provided with the electronic tag is used for printing pages other than the first page and the last page.

5. An image forming device as claimed in claim 1, wherein
said second mode execution unit selects a plurality of recording media each provided with the electronic tag.

6. An image forming device as claimed in claim 5, wherein
said second mode execution unit selects additional recording medium provided with an electronic tag if the entire image data for printing cannot be written into an electronic tag of a single recording medium.

7. An image forming device as claimed in claim 5, wherein
said recording media each provided with the electronic tag are used for printing pages starting with the first page and continuing thereafter.

8. An image forming device as claimed in claim 5, wherein
said recording media each provided with the electronic tag are used for printing continuation pages other than the first page and the last page.

9. An image forming device as claimed in claim 1, wherein the bundling process is at least one of stapling, punching and book binding processes.

10. An image forming device, comprising:
a judgment unit for making a judgment on whether a bundling process for bundling a plurality of printed recording media is instructed or not, when a process for writing image data to be printed on the recording media into an electronic tag is instructed;
a first mode execution unit for executing a first mode of selecting only recording media each provided with an electronic tag as the recording media for printing and writing into the electronic tag of each recording medium the image data to be printed on the corresponding recording medium, when it is judged that said bundling process is not instructed; and
a second mode execution unit for executing a second mode of selecting only a recording medium provided with no electronic tag for printing and writing into an electronic tag of a bundling member equipped with the electronic tag used for said bundling process the entire image data to be printed on a plurality of recording media, when it is judged that said bundling process is instructed.

11. An image forming device as claimed in claim 10, wherein
said bundling process is at least one of stapling, punching and book binding processes.

12. An image forming method comprising the steps of:
1) making a judgment on whether a bundling process for bundling a plurality of printed recording media is instructed or not, when a process for writing image data to be printed on the recording media into an electronic tag is instructed;
2) executing a first mode of selecting only recording media each provided with an electronic tag as the recording media for printing and writing into the electronic tag of each recording medium the image data to be printed on the corresponding recording medium, when it is judged that said bundling process is not instructed; and
3) executing a second mode of selecting a recording medium provided with an electronic tag and a recording medium provided with no electronic tag as the recording media for printing and writing into said electronic tag of the recording medium provided with the electronic tag the entire image data to be printed on a plurality of recording media, when it is judged that said bundling process is instructed.

13. An image forming method comprising the steps of:
1) making a judgment on whether a bundling process for bundling a plurality of printed recording media is instructed or not, when a process for writing image data to be printed on the recording media into an electronic tag is instructed;
2) executing a first mode of selecting only recording media each provided with an electronic tag as the recording media for printing and writing into the electronic tag of each recording medium the image data to be printed on the corresponding recording medium, when it is judged that said bundling process is not instructed; and
3) executing a second mode of selecting only a recording medium provided with no electronic tag for printing and writing into an electronic tag of a bundling member equipped with the electronic tag used for said bundling process the entire image data to be printed on a plurality of recording media, when it is judged that said bundling process is instructed.

14. A computer readable recording medium stored with an image forming program, said image forming program causing an image forming device to execute a process comprising the steps of:
1) making a judgment on whether a bundling process for bundling a plurality of printed recording media is instructed or not, when a process for writing image data to be printed on the recording media into an electronic tag is instructed;
2) executing a first mode of selecting only recording media each provided with an electronic tag as the recording media for printing and writing into the electronic tag of each recording medium the image data to be printed on the corresponding recording medium, when it is judged that said bundling process is not instructed; and
3) executing a second mode of selecting a recording medium provided with an electronic tag and a recording medium provided with no electronic tag as the recording media for printing and writing into said electronic tag of the recording medium provided with the electronic tag the entire image data to be printed on a plurality of recording media, when it is judged that said bundling process is instructed.

15. A computer readable recording medium stored with an image forming program, said image forming program causing an image forming device to execute a process comprising the steps of:
1) making a judgment on whether a bundling process for bundling a plurality of printed recording media is instructed or not, when a process for writing image data to be printed on the recording media into an electronic tag is instructed;
2) executing a first mode of selecting only recording media each provided with an electronic tag as the recording media for printing and writing into the electronic tag of each recording medium the image data to be printed on the corresponding recording medium, when it is judged that said bundling process is not instructed; and
3) executing a second mode of selecting only a recording medium provided with no electronic tag for printing and writing into an electronic tag of a bundling member equipped with the electronic tag used for said bundling process the entire image data to be printed on a plurality of recording media, when it is judged that said bundling process is instructed.

16. An image forming device, comprising:
a receiving unit for receiving a printing job;
an image forming unit for printing on recording media in accordance with the printing job; and
a data writing unit for writing electronic data in accordance with the printing job into an electronic tag of the recording media;
wherein the data writing unit writes electronic data in the electronic tag of the recording media of the number of sheets that is less than the printed number of sheets when printing on two or more sheets of paper based on the printing job.

17. An image forming device as claimed in claim 16, wherein said data writing unit writes electronic data in the electronic tag of the recording media corresponding to the first page.

18. An image forming device as claimed in claim 16, wherein said data writing unit writes electronic data in the electronic tag of the recording media of the number of sheets necessary to write all electronic data in accordance with the printing job.

19. An image forming device as claimed in claim 16, wherein said data writing unit writes electronic data in the electronic tag of the recording media corresponding to pages other than the first page and the last page.

20. An image forming device as claimed in claim 16, wherein said data writing unit writes electronic data in the electronic tag of the recording media of the number of sheets that is less than the printed number of sheets when a bundling process for bundling a plurality of printed recording media is instructed.

21. An image forming device as claimed in claim 20, wherein the bundling process is at least one of stapling, punching and book binding processes.
